(19) United States
(12) Patent Application Publication
(10) Pub. No.: US 2006/0048635 A1
(43) Pub. Date: Mar. 9, 2006

(54) System for digitally transmitting audio data from individual electric guitar strings

(76) Inventor: Jack Campbell, Hendersonville, TN (US)

Correspondence Address: W. EDWARD RAMAGE, COMMERCE CENTER SUITE 1000, 211 COMMERCE ST, NASHVILLE, TN, 37201, US

(21) Appl. No.: 11/223,349

(22) Filed: Sep. 9, 2005

Related U.S. Application Data
(60) Provisional application No. 60/608,392, filed on Sep. 9, 2004.

(51) Int. Cl. G10H 3/12; G10H 1/18

(52) U.S. Cl. 84/742

(57) ABSTRACT

A system for converting output signals from the individual pickup coils of an electric guitar to a high quality digital signal, transmitting that signal from the guitar to a computer or outboard decoding device, and remotely making connections or adjustments to the signals. The system is unidirectional, and maintains compatibility with existing analog connection equipment, while permitting software-based adjustments to the sound from each individual string. An outboard connection device may be used to provide output jacks for each resulting individual signal.

This application claims benefit of the previously filed Provisional Patent Application No. 60/608,392, filed Sep. 9, 2004, by Jack Campbell, the specification and contents of which are incorporated herein by reference, and is entitled to that filing date for priority.

### FIELD OF INVENTION

This invention relates to a system for audio signal processing and transmission. More particularly, the present invention relates to a system for electric guitar signal processing that converts the individual coil outputs from an electric guitar magnetic pickup to individual digital signals, and then transmits those digital signals for processing on a connected computer, or to an outboard housing that converts the signals to individual analog signals.

### BACKGROUND OF INVENTION

Stringed musical instruments generate sound by the vibration of the strings, which vibrate at different frequencies to generate notes with varying pitches. Most stringed instruments, such as guitars, locate the strings on or near a sound chamber or board to combine and amplify the sound.

With the creation of electrical musical instruments, however, the hollow sound chamber is replaced by an electric power amplifier. Electrical transducers (“pickups”) sense the vibrations of the strings, and convert the vibrations into an electrical signal. With the electric guitar, for example, the normal method of creating sound, transmitting the sound, and amplifying the sound from the guitar strings has been to use an analog pickup mounted under the steel strings of the guitar, and then to pass the signal from the pickup through an analog cable out of the guitar to an analog amplifier system. The signal can then be amplified and broadcast through headphones or loudspeakers.

Ideally, the vibration of each string is separately transduced and amplified for greatest fidelity. A variety of factors, however, has caused electrical instruments such as electric guitars to use a smaller number of electrical pickups than the number of strings on the instrument. It has been common for electrical guitars to use an electric coil analog pickup that spans several strings. While the guitar analog pickup usually has individual magnetic coils, one for each guitar string, the traditional design approach has summed those individual coil output signals into one monophonic audio signal, making the adjustment of the sound from any one guitar string impossible. It has been common for electrical guitars to use an electric coil analog pickup that spans several strings. The resulting monophonic audio signal makes the adjustment of the sound from any one guitar string impossible.

Recent developments have brought a number of electric guitars to market that create and send MIDI signals when the strings are struck, and these MIDI signals are then interpreted by outboard devices or computers. While transmitting information pertaining to the activity of each of the guitar strings, a MIDI-based approach does not actually transmit music audio from the guitar analog pickup, as MIDI is merely a voiceless numeric representation of pitch and amplitude.

Electric guitars that provide conversion of each individual guitar string are known in the prior art. For example, Gibson Guitar Co. has publicly shown a bi-directional interconnection scheme in Pat. No. 6,686,530 where one embodiment would include an electric guitar that does provide individual analog-to-digital conversion of each individual string sound from the pickup. However, in Gibson's design, the resulting digital signal is transmitted from the guitar via a proprietary bi-directional connection scheme loosely based upon the Ethernet networking standard. While including the functionality of digitally transmitting the audio signal from each pickup coil, Gibson's approach, by including an array of additional functionality, is extraordinarily complex and expensive, making the system unaffordable for most guitarists.

Accordingly, what is needed is a simple and inexpensive method for converting the output signals from the individual pickup coils on an electric guitar to a high quality digital signal, transmitting that signal from the guitar to a computer or to an outboard decoding device, and then remotely making connections or adjustments to the signals from the individual guitar pickup coils.

### SUMMARY OF THE INVENTION

The present invention provides for a system capable of simply and inexpensively converting the output signals from the individual pickup coils of an electric guitar to a high quality digital signal, transmitting that signal from the guitar to a computer or to an outboard decoding device, and then remotely making connections or adjustments to the signals from the individual guitar pickup coils. Because the system is unidirectional in that it only converts and transmits data in one direction (i.e., away from the pickup coils), and uses industry standard universal serial bus based digital audio and connectors, the invention can be implemented at low cost and with little complexity.

This invention provides the guitarist with a simple and affordable system that provides both a digital and an analog connection point on the electric guitar. Accordingly, compatibility with existing analog connection equipment is maintained while the benefits of adjusting the sound from the individual guitar strings can be achieved through the digital connection to either a computer or an outboard connection device. With a computer, software decodes the digital audio signal into individual guitar string sound components and permits software-based adjustments to the sound from each individual guitar string. With an outboard connection device, the digital audio signal from the guitar is decoded into individual guitar string components, and analog jacks are provided for each resulting individual signal; this enables the use of existing analog sound processing equipment for making adjustments to the sound from each guitar string.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### DESCRIPTION OF THE DRAWINGS

FIG. 1 shows a perspective view of one embodiment of the present invention.

### DETAILED DESCRIPTION OF THE INVENTION

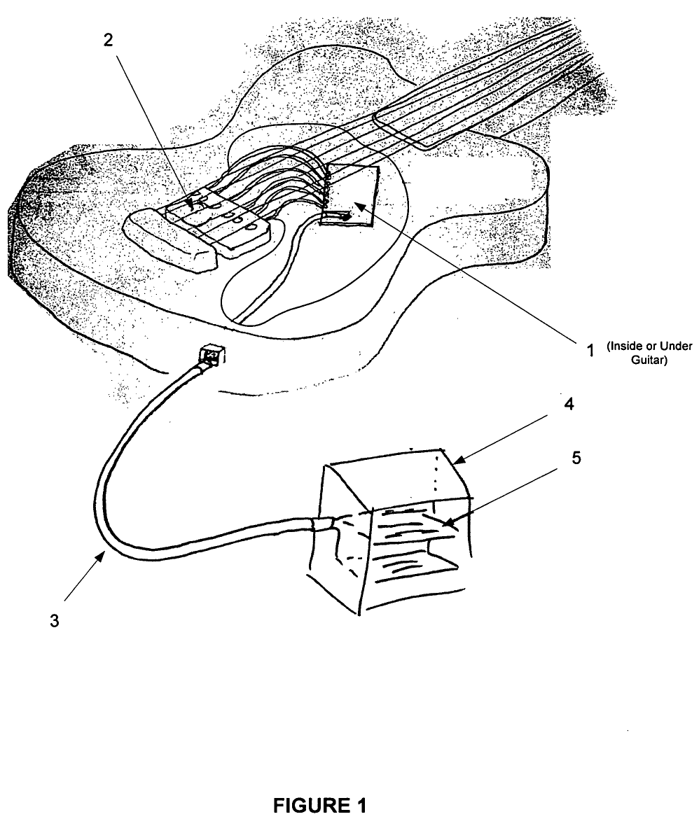

Referring now to the numerous figures, wherein like references identify like elements of the invention, FIG. 1 illustrates an exemplary embodiment of the invention comprising an audio converter circuit 1 physically mounted within the body of an electric guitar. In one embodiment of the invention, the audio converter circuit 1 comprises a universal serial bus analog-to-digital audio converter circuit. The audio converter circuit 1 is wired through one or more inputs to one or more magnetic pickup coils 2 magnetically coupled to the strings of the guitar. The audio converter circuit 1 emits a digital audio output signal to a universal serial bus jack 3, typically a Type “B” universial serial bus jack, located on the body of the guitar.

The universal serial bus jack 3 is connected to a universal serial bus jack, typically a Type “A” universal serial bus jack, on a computer 4 or a conversion device with a plurality of digital-to-analog audio converter circuits 5. The connection is made by suitable means, such as a universal serial bus cable 6. If the digital audio output signal is sent to a computer 4, the signal is then processed by software to enable effects processing of the individual signals originally emitted from the individual coils of the magnetic electric guitar pickup. Alternatively, if the digital audio output signal is sent to a conversion device 4, the digital-to-analog converter circuits 5 convert the digital audio output information into individual analog output signals, which can then be output through analog output means, such as a one-quarter-inch phono jack.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. An apparatus for processing audio signals from individual coils of a magnetic electric guitar pickup, comprising:
a. an audio converter circuit, comprising a plurality of input means electrically connected to a plurality of electric guitar pickup coils; and
b. means for converting the input from said electric guitar pickup coils to a digital audio output signal.

2. The apparatus of claim 1, further wherein the audio converter circuit is a universal serial bus analog-to-digital audio converter circuit.

3. The apparatus of claim 1, further comprising means for transmitting the digital audio output signal.

4. The apparatus of claim 3, wherein the means for transmitting comprises a universal serial bus jack.

5. The apparatus of claim 1, further comprising means for transmitting a monophonic bypass signal.

6. The apparatus of claim 5, wherein the means for transmitting comprises a one-quarter-inch phono jack connector.

7. The apparatus of claim 4, further comprising a universal serial bus cable with two ends, the first end connected to the universal serial bus jack on the guitar, and the second end connected to a universal serial bus jack mounted on a computer.

8. The apparatus of claim 6, further comprising a 2-conductor cable with two ends, the first end connected to the one-quarter-inch phono jack on the guitar body, and the second end connected to a one-quarter-inch phono jack physically mounted on a guitar amplifier, for sending a monophonic bypass signal that is the sum of all individual signals from the magnetic pickup coils to an amplifier or similar device.

9. The apparatus of claim 7, wherein the digital audio signal is processed by software on the computer to enable effects processing of the individual signals originally emitted from the individual coils of a magnetic electric guitar pickup.

10. The apparatus of claim 4, further comprising a universal serial bus cable with two ends, the first end connected to the universal serial bus jack on the guitar, and the second end connected to a universal serial bus jack mounted on a device that contains a plurality of digital-to-analog audio converter circuits.

11. The apparatus of claim 10, wherein said device converts the digital audio information into individual analog audio signals.

12. The apparatus of claim 11, further comprising a plurality of analog audio output means.

13. The apparatus of claim 12, wherein said output means comprise one-quarter-inch phono jacks.

14. A method for processing audio signals from individual coils of a magnetic electric guitar pickup, comprising the steps of:
a. receiving output signals from the individual coils;
b. converting each signal to a digital signal;
c. transmitting the digital signals to a receiving device.

15. The method of claim 14, wherein the receiving device is a computer.

16. The method of claim 14, wherein the receiving device is an outboard connection device.

17. The method of claim 14, further comprising the step of adjusting the characteristics of one or more of the digital signals.
